(19) United States
(12) Patent Application Publication
(10) Pub. No.: US 2019/0373349 A1
(43) Pub. Date: Dec. 5, 2019

(54) MOUNTING APPARATUS FOR MOUNTABLE DEVICES

(71) Applicant: EAW NORTH AMERICA, INC., Whitinsville, MA (US)

(72) Inventors: ROBERT GERALD CARRASCA, SEATTLE, WA (US); CHRISTOPHER ROSS HAMLIN, SEATTLE, WA (US); DYLAN JAMES PIPER-KAISER, SEATTLE, WA (US)

(21) Appl. No.: 16/424,120

(22) Filed: May 28, 2019

Related U.S. Application Data
(60) Provisional application No. 62/680,192, filed on Jun. 4, 2018.

(51) Int. Cl. H04R 1/02; F16M 13/02; H04R 1/32

(52) U.S. Cl. CPC H04R 1/026; F16M 13/022; H04R 2201/025; F16M 2200/022; H04R 1/323

(57) ABSTRACT

A mounting apparatus for mountable devices such as speakers. Preferably two device mounting members are fixed to a speaker and two fixed mounting members are fixed to a wall. The speaker is then moved horizontally so that the device mounting members releasably snap into engagement with the fixed mounting members. The speaker can be rotated left/right and locked in position. The speaker can be installed and uninstalled by a single person.

### FIELD OF THE INVENTION

This invention relates to mounting apparatus for mountable devices, such as speakers, such as audio speakers. The entire contents of U.S. Provisional Patent Application No. 62/680,192 filed on Jun. 4, 2018 is hereby incorporated by reference herein.

### BACKGROUND OF THE INVENTION

It is difficult to mount and unmount audio speakers and other mountable devices, such as in a home, concert hall, large room, auditorium, outdoor arena, theater, etc. There is a need for a mounting apparatus whereby a device such as a speaker can be slid horizontally into a slot or space and mounted to a support structure by a single person, whereby the device or speaker snaps in place in the mounting apparatus or brackets, and can be unmounted by a single person.

### SUMMARY OF THE INVENTION

A mounting apparatus for a mountable device, the mounting apparatus comprising a first device mounting member and a first fixed mounting member, the first device mounting member having (a) a recess extending vertically and (b) an entrance-way which is provided with an angled surface, the entrance-way extending towards the recess, the first fixed mounting member having (a) a plunger securement device slidable in an aperture extending vertically in the first fixed mounting member and (b) a biasing element which provides a biasing force, the plunger securement device having a plunger pin at a first end and a knob at a second end, the biasing element being effective to bias the plunger pin in an extended position extending from the aperture, the first fixed mounting member having a horizontal contacting surface adjacent the plunger pin which is slidable with respect to a horizontal contacting surface of the first device mounting member adjacent the recess of the first device mounting member such that, when a distal portion of the first fixed mounting member horizontal contacting surface slides a first distance on or towards the first device mounting member horizontal contacting surface, a distal portion of the plunger pin contacts the angled surface, which forces the plunger pin to retract in a direction into the aperture and against the biasing force, and when the distal portion of the first fixed mounting member horizontal contacting surface slides a further distance on the first device mounting member horizontal contacting surface, the distal portion of the plunger pin arrives at the recess and extends into the recess via the biasing force.

### BRIEF DESCRIPTION OF THE DRAWINGS

This disclosure presents in detail the following description of preferred embodiments with reference to the following figures wherein:

FIG. 1 is a perspective view of the mounting system or apparatus with a speaker and a bracket for mounting to a wall;

FIG. 2 is a perspective view of a lower device mounting member and lower fixed mounting member as the lower device mounting member is moved towards a wall or other support structure;

FIG. 3 is a perspective view of the lower device mounting member and lower fixed mounting member as the lower device mounting member is moved towards a wall which shows the interior of the lower device mounting member;

FIG. 4 is a perspective view of the lower device mounting member and lower fixed mounting member as the plunger pin is received in the recess of the device mounting member;

FIG. 5 is a perspective view of the lower device mounting member and lower fixed mounting member with the plunger pin being positioned within the recess of the device mounting member;

FIG. 6 is a perspective view of the lower device mounting member and lower fixed mounting member with the plunger pin being positioned within the recess of the device mounting member and including locking means;

FIG. 7 is a perspective view of the upper device mounting member and upper fixed mounting member in a first rotational orientation;

FIG. 8 is a perspective view of the upper device mounting member and upper fixed mounting member in a second rotational orientation;

FIG. 9 is a perspective view of the lower device mounting member and lower fixed mounting member in a locked position;

FIG. 10 is a schematic illustration showing a schematic cross-sectional view taken along a line similar to line 10-10 in FIG. 7; and

FIG. 11 is a schematic illustration taken along a line similar to line 11-11 in FIG. 7.

### DETAILED DESCRIPTION OF PREFERRED EMBODIMENTS OF THE INVENTION

A mounting system or apparatus for a speaker or other mountable device is provided. The mounting apparatus features a fixed (or wall) mounting member which is releasably secured to a device (or cabinet) mounting member by a plunger securement device to provide an efficient, secure and precise installation which can be performed by a single installer. The mounting apparatus permits a speaker to be installed or removed without requiring the speaker to be tilted so that a speaker positioned between other speakers (such as a middle speaker of a stacked array) may be installed or removed without needing to remove any adjacent speakers. The mounting apparatus also provides for rotational adjustment of the device mounting member when the device mounting member is releasably secured to the fixed mounting member for more precise positioning of the speaker during installation.

All statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Reference in the specification to “one embodiment” or “an embodiment” of the present principles, as well as other variations thereof, means that a particular feature, structure, characteristic, and so forth described in connection with the embodiment is included in at least one embodiment of the present invention or principles. Thus, the appearances of the phrase “in one embodiment” or “in an embodiment”, as well as any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent to one of ordinary skill in this and related arts, for as many items listed. It will also be understood that when an element is referred to as being “connected” or “coupled” to another element, it can be directly connected or coupled to the other element or intervening elements may be present.

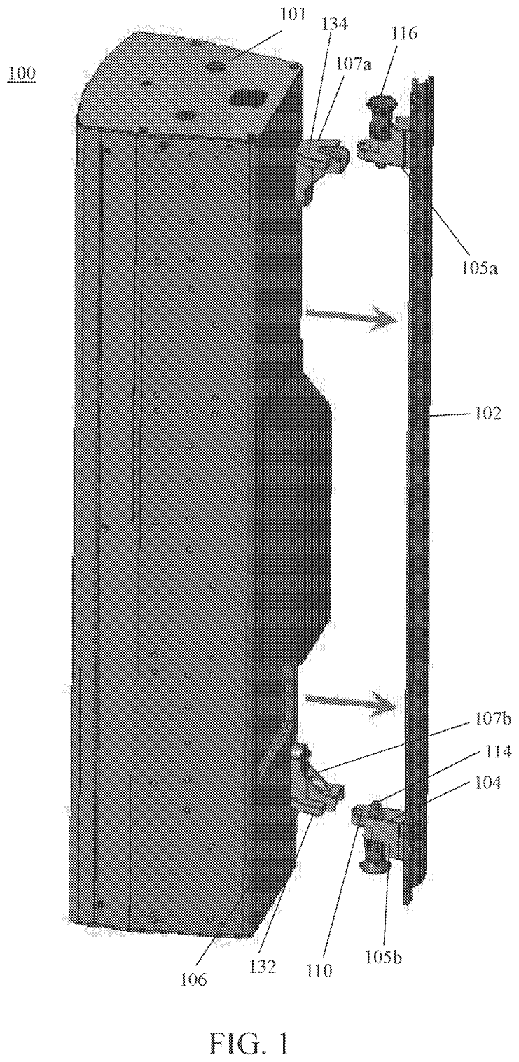

Referring now to the drawings in which like numerals represent the same or similar elements and initially to FIG. 1, a mounting apparatus or system 100 is provided. The mounting apparatus 100 is configured for securing mountable devices, such as speakers 101, to a wall or another speaker or other support structure or fixed or stationary structure or mounting member. While the embodiments in the present application specifically describe the mountable device as an audio speaker 101 for illustrative purposes, the mounting apparatus 100 may be utilized in connection with any other mountable device and in any other field of art.

The mounting apparatus 100 includes a wall bracket 102 that is configured to be mounted to a wall or other support structure via fixing means known in the art such as screws, anchors, etc. The wall bracket 102 may be any existing wall bracket known in the art.

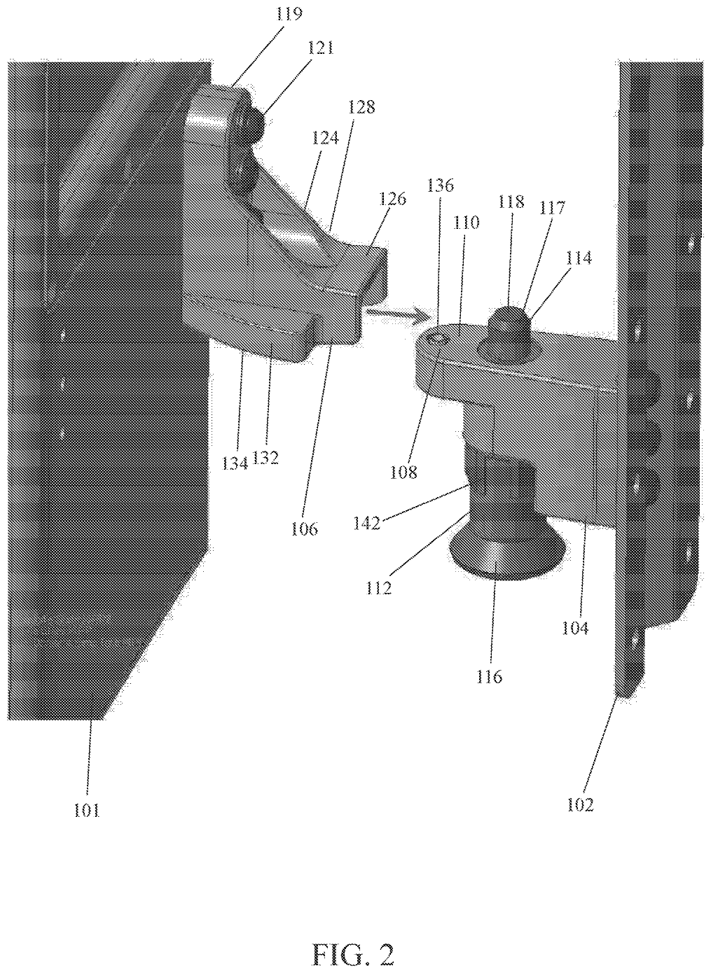

The mounting apparatus 100 includes at least one wall mounting member or fixed mounting member 104 (see FIG. 2) that is configured to be secured to the wall bracket 102, or it can be secured directly to the wall or other support structure. The fixed mounting member 104 may be releasably secured to the wall bracket 102 by screws, bolts or other means known in the art. The fixed mounting member 104 is configured to be releasably secured to a device mounting member or cabinet mounting member 106 which is fixed to the cabinet of the speaker 101 or other mountable device.

As shown in FIG. 1, the mounting apparatus 100 may include an upper fixed mounting member 105a and a lower fixed mounting member 105b which are configured to be secured to upper device mounting member 107a and lower device mounting member 107b, respectively. However, in other embodiments, the mounting apparatus 100 may include three or more fixed mounting members and device mounting members or only a single fixed mounting member and device mounting member for securing the speaker 101 or other mountable device.

As shown in FIG. 2, the fixed mounting member 104 has a distal portion 108. The fixed mounting member also has a contacting or support surface 110 configured for supporting a contacting surface 134 of the device mounting member 106. The body of the fixed mounting member 104 has a first aperture which is preferably cylindrical. A plunger securement device 112 is secured to the fixed mounting member 104 and is positioned adjacent, to and within, the first aperture and is slidable in the first aperture.

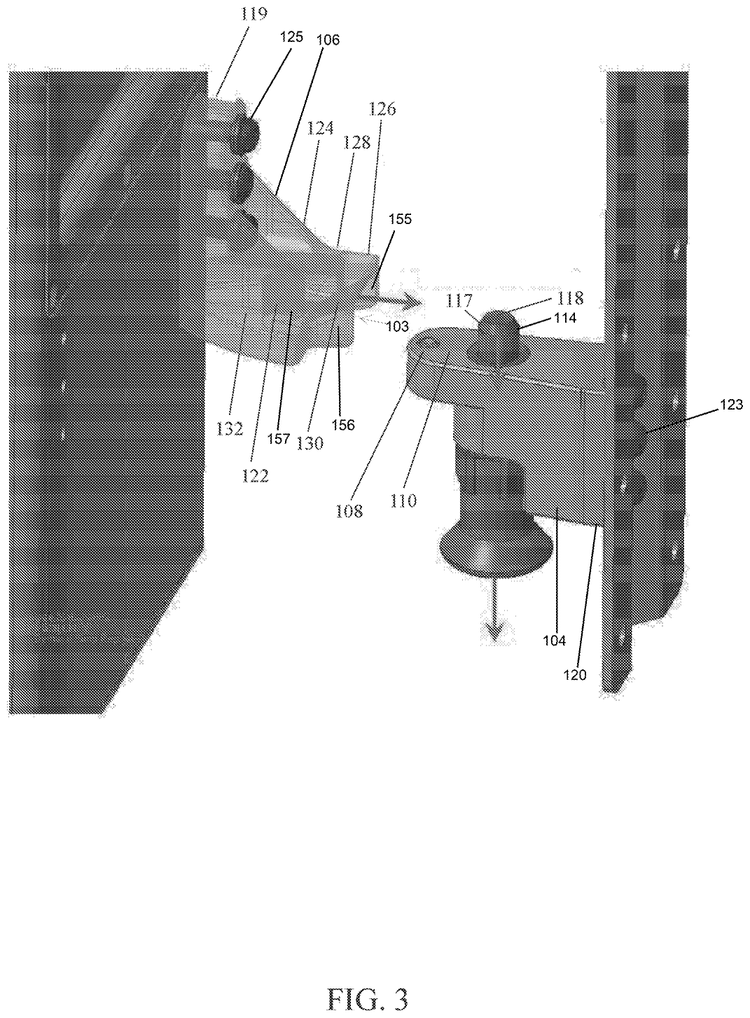

The plunger securement device 112 includes a plunger pin 114 on a first end and a knob 116 on a second end. The plunger securement device 112 also includes biasing means that is configured to force, via a biasing force, the distal end 118 of the plunger pin through the first aperture in the fixed mounting member; the plunger pin 114 is shown in FIG. 3 in an extended position extending from the first aperture. The biasing means may be a spring or any other device that provides a biasing force as known in the art.

For example, in the embodiment shown in FIG. 1, the knob 116 of the plunger securement device on the upper fixed mounting member 105a is positioned on an upper surface of the fixed mounting member and the plunger pin 114 is biased downwardly so that the plunger pin extends below a support surface of the upper fixed mounting member. The knob 116 of the plunger securement device 112 on the lower fixed mounting member 105b is positioned on a lower surface of the fixed mounting member and the plunger pin 114 is biased upwardly so that the plunger pin extends above a support surface 110 of the lower fixed mounting member. However, the plunger securement device 112, fixed mounting member 104 and device mounting member 106 may be configured in other orientations with respect to each other, as may be desired.

The distal end 118 of the plunger pin includes an angled or beveled surface 117. For example, in the embodiment shown in FIG. 2, the angled surface 117 is an inclined portion extending from the outer perimeter of the pin towards the center forming a raised, flat center portion.

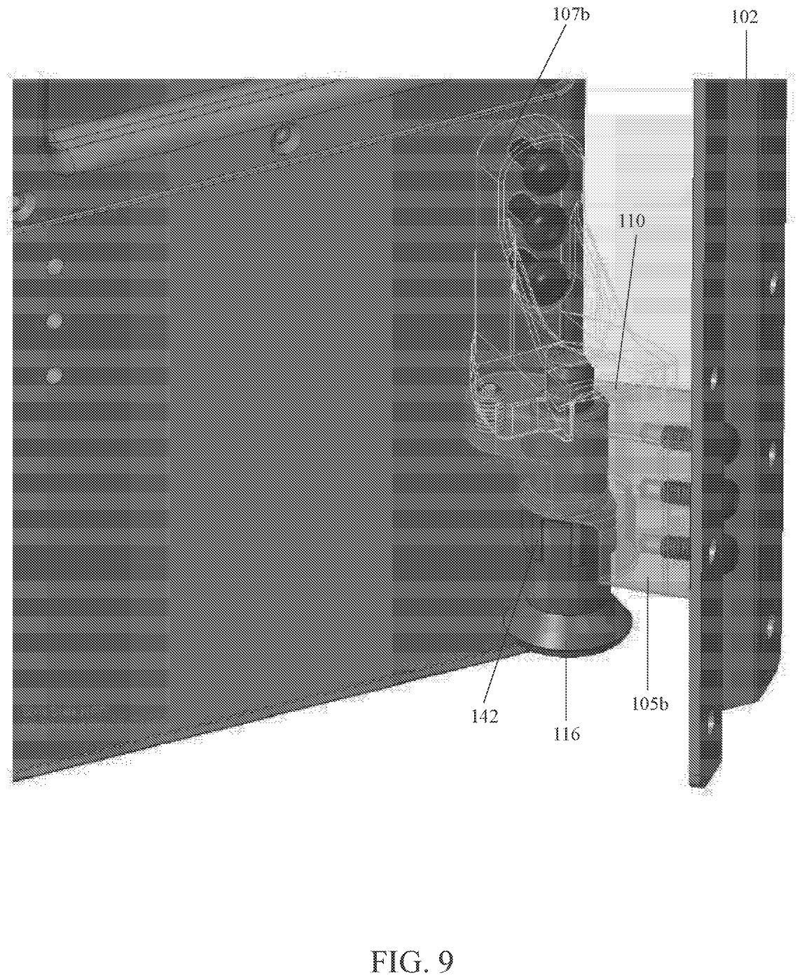

The fixed mounting member 104 also includes a distal aperture 136 proximate the distal end of the fixed mounting member. The distal aperture 136 is configured to receive locking means 138. For example, in the embodiment shown in FIGS. 2, 6 and 9, the distal aperture 136 is threaded and is configured to receive a set screw 140 as the locking means 138. The set screw 140 may have a knurled face on its distal end.

The device mounting member 106 of the mounting apparatus 100 has a proximal end 119 having fixing means 121 for releasably securing the device mounting member 106 to the speaker 101 or other mountable device. The fixing means 121 may be screws, bolts or other means known in the art. For example, as shown in FIGS. 2-6, 8 and 9, the fixing means 121 may be screws that are received in a plurality of vertically spaced apertures on the cabinet of the speaker 101. In the embodiment shown in FIGS. 2-6, 8 and 9, the cabinet includes separate vertically spaced apertures on the left and right side of the cabinet to enable the device mounting member 106 to be secured to the cabinet at different portions of the cabinet, as may be desired. The speaker cabinet may also have three or more sets of apertures and the apertures may be arranged in any other orientation.

With reference to FIG. 3, the device mounting member 106 and the fixed mounting member 104 have proximal portions 119 and 120, respectively, which have a plurality of apertures, cavities or fastening elements (indicated at 125 and 123 respectively) which are configured so that the respective mounting member can be secured to a respective mountable device or a support structure.

With reference to FIG. 3, the device mounting member 106 defines an entrance-way 103 which can be in the nature of a slot or channel; as shown, angled surface 130 can form a roof or upper boundary of the entrance-way 103 and sidewalls 155, 156 can form side boundaries. As shown, the entrance-way 103 extends towards the recess 122. The entrance-way 103 is configured to guide and channel the plunger pin 114 towards the mouth 157 of the recess 122 so that the plunger pin can snap into and engage the recess. As shown, angled surface 130 extends generally in a direction towards the mouth 157 of recess 122.

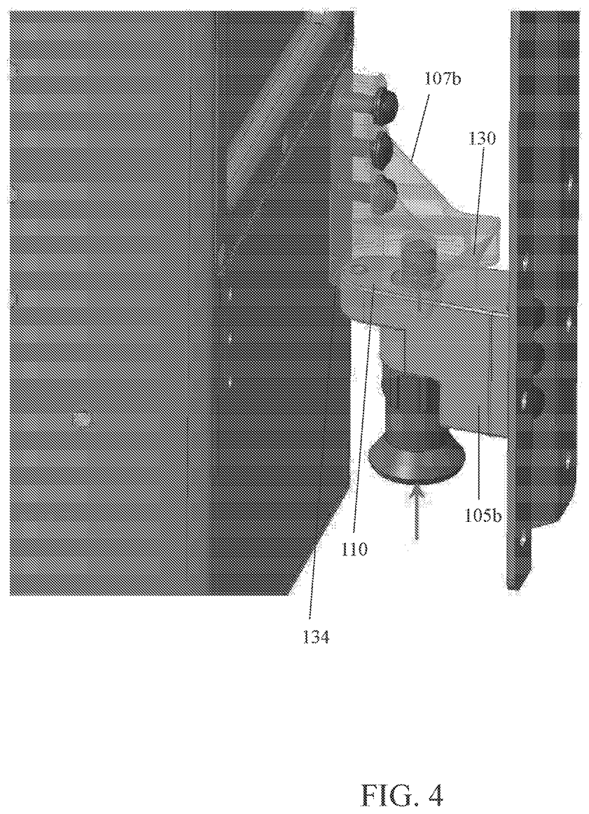

As shown in FIGS. 3-6, a middle portion 124 of the body of the device mounting member 106 that is spaced away from the distal end 126 includes a recess or cavity 122 (which can be open or closed at the far end) that is configured to receive the distal end 118 of the plunger pin. The recess 122 and the plunger pin 114 are preferably cylindrical. A distal portion 128 of the device mounting member 106 that extends from the distal end 126 to a surface adjacent the recess 122 includes an angled surface or ramp or sloped surface 130 which is preferably planar or flat. For example, as shown in FIGS. 3-4, the lower device mounting member 107b may have an angled surface 130 that is a relatively planar, inclined surface. The upper device mounting member 107a may have an angled surface 130 that is a relatively planar, declined surface. The angled surface 130 in one embodiment has an inclined or declined angle between 15 degrees and 75 degrees. In another embodiment, the angled surface 130 has an inclined or declined angle between 30 and 50 degrees. While the cabinet 101 is being pushed into position, the inclined surface 130 of the device mounting member will compress the spring-loaded plunger pin in the fixed mounting member.

The device mounting member 106 may also include laterally extending portions 132 on its sides. In one embodiment, the laterally extending portions 132 widen from the proximal end 119 of the device mounting member to the distal portion 128 of the device mounting member. In one embodiment, the laterally extending portions 132 terminate at the distal portion 128 of the device mounting member 106 before the angled surface 130 begins to incline or decline.

The mounting apparatus 100 permits an installer to easily mount the speaker 101 to the wall or other support structure. The device mounting member 106 is secured to the fixed mounting member 104 by moving the speaker 101 so that the distal end 126 of the device mounting member is moved into contact with the distal portion 108 of the fixed mounting member. The speaker is then moved towards the wall. As shown in FIG. 3, when the angled surface 130 of the device mounting member contacts the angled surface 117 of the distal end 118 of the plunger pin 114, the angled surface 130 of the device mounting member 106 exerts pressure on the plunger pin 114 that opposes the biasing force provided by the biasing means. As the speaker 101 is moved further towards the wall, the distal end 118 of the plunger pin 114 is forced by the angled surface 130 of the device mounting member further into the first aperture until the plunger pin preferably does not extend outside the first aperture of the fixed mounting member. As shown in FIG. 4, when speaker 101 is further moved so that the recess 122 of the device mounting member extends over the first aperture of the fixed mounting member, the biasing means forces the distal end 118 of the plunger pin into the recess which releasably secures the device mounting member 106 to the fixed mounting member 104.

For example, when the distal end of the upper device mounting member 107a contacts the distal end of the upper fixed mounting member 105a and is moved horizontally towards the wall, the relatively planar, declined surface of the upper device mounting member contacts the angled surface 117 of the distal end of the plunger pin and pushes the plunger pin upwardly into the first aperture of the fixed mounting member. When the recess 122 of the upper device mounting member extends under the first aperture of the upper fixed mounting member, the biasing means forces the distal end 118 of the plunger pin of the fixed mounting member to snap downwardly to extend out of the first aperture and snap into the recess to secure the upper device mounting member to the upper fixed mounting member.

As shown in FIGS. 3-4, when the distal end of the lower device mounting member 107b contacts the distal end of the lower fixed mounting member 105b and is moved horizontally towards the wall, the relatively planar, inclined surface 130 of the lower device mounting member contacts the angled surface 117 of the distal end 118 of the plunger pin 114 and pushes the plunger pin downwardly into the aperture of the fixed mounting member. When the recess 122 of the lower device mounting member extends above the first aperture of the lower fixed mounting member, the biasing means forces the distal end 118 of the plunger pin of the lower fixed mounting member to snap upwardly to extend out of the first aperture and snap into the recess to secure the lower device mounting member to the lower fixed mounting member.

The angled surface 117 of the distal end of the plunger pin and the angled surface 130 of the device mounting member may have surfaces with matching inclining/declining angles and which may reduce friction between the two surfaces.

Due to the configuration of the device mounting member 106 and the fixed mounting member 104, the installer can maintain the speaker 101 upright and level without the installer needing to tilt the speaker in order to secure the device mounting member to the fixed mounting member. For example, in the illustrative embodiments shown in FIGS. 1-5, the installer is able to maintain the speaker in an upright and level orientation and only move the speaker horizontally in the direction towards the wall in order to secure the device mounting member on the speaker cabinet to the fixed mounting member secured to the wall.

These features permit the installer to efficiently and effectively install the speaker even when the device has other speakers stacked above and below the device. In contrast, mounting devices known in the art typically require the speaker to be tilted in order to mount the device. Since stacked speakers usually have minimal space between adjacent speakers (e.g., ⅛ inch), there is normally insufficient room to tilt the speakers during an installation. Therefore, speakers above and/or below a speaker would normally need to be removed so that a speaker that is being installed or serviced may be mounted or removed. This problem of prior art devices also limits the potential speaker configurations which may be used for particular applications.

As shown in FIG. 4, when the distal end 118 of the plunger pin of the fixed mounting member is received in the recess 122 of the device mounting member and the device mounting member is secured to the fixed mounting member, a contacting surface 134 of the device mounting member contacts the contacting or support surface 110 of the fixed mounting member. For example, as shown in FIG. 4, when the lower device mounting member 107b is secured to the lower fixed mounting member 105b, the lower device mounting member rests on top of the lower fixed mounting member and the contacting surface 134 is positioned on the bottom of the device mounting member. As shown in FIG. 1, when the upper device mounting member 107a is secured to the upper fixed mounting member 105a, the upper device mounting member is positioned below the upper fixed mounting member and the contacting surface 134 is positioned on the upper portion of the device mounting member. The contacting surface 134 of the device mounting member preferably has contours which complement the dimensions of the contacting or supporting surface 110 of the fixed mounting member. In the embodiments shown, the contacting surface 134 of the device mounting member and the contacting surface 110 of the fixed mounting member are both relatively planar, flat and level. The bottoms of the sidewalls 155, 156 can form part of the contacting surface 134.

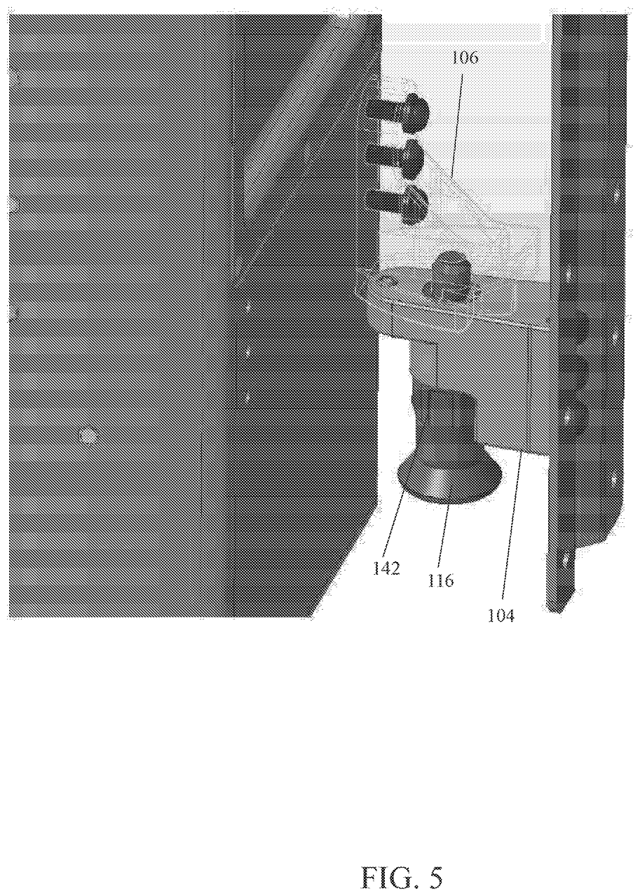

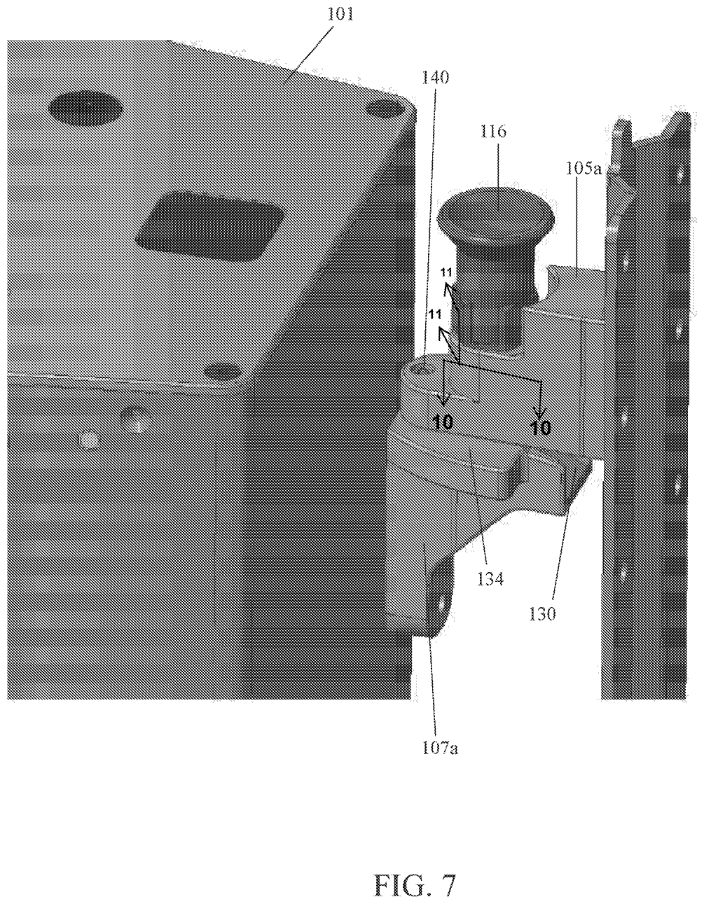

As shown in FIGS. 5, 7 and 8, when the device mounting member 106 and the fixed mounting member 104 are secured to or engaged with each other by moving the distal end 118 of the plunger pin of the fixed mounting member into the recess 122 of the device mounting member, the device mounting member is able to be rotated axially, preferably at least 90° or 180° around a vertical axis with respect to its respective fixed mounting member. The contacting surface 110 of the fixed mounting member and the contacting surface 134 of the device mounting member preferably have surfaces which are free of encumbrances so that rotation around a vertical axis is not restricted. In one embodiment, the device mounting member 106 may be rotated around a vertical axis approximately or at least 180 degrees when secured to the fixed mounting member. In another embodiment, the device mounting member may be rotated approximately or at least 90 degrees when secured to the fixed mounting member.

The rotation of the device mounting member with respect to the fixed mounting member provided by the mounting apparatus permits an installer to adjust the position of the speaker 101 radially after the speaker has been secured to the fixed mounting member. This provides an improved ability for the installer to position the mounted device. For example, the pan position of the speakers may be adjusted after being secured to the fixed mounting member. The installer may also choose different areas of the speaker cabinet to secure the device mounting member to in order to further vary the potential positioning and rotation of the speaker. For example, the vertically aligned apertures for the fixing means on the left side may provide a better range of pan rotation for the speakers as opposed to other sets of apertures for the fixing means in certain applications.

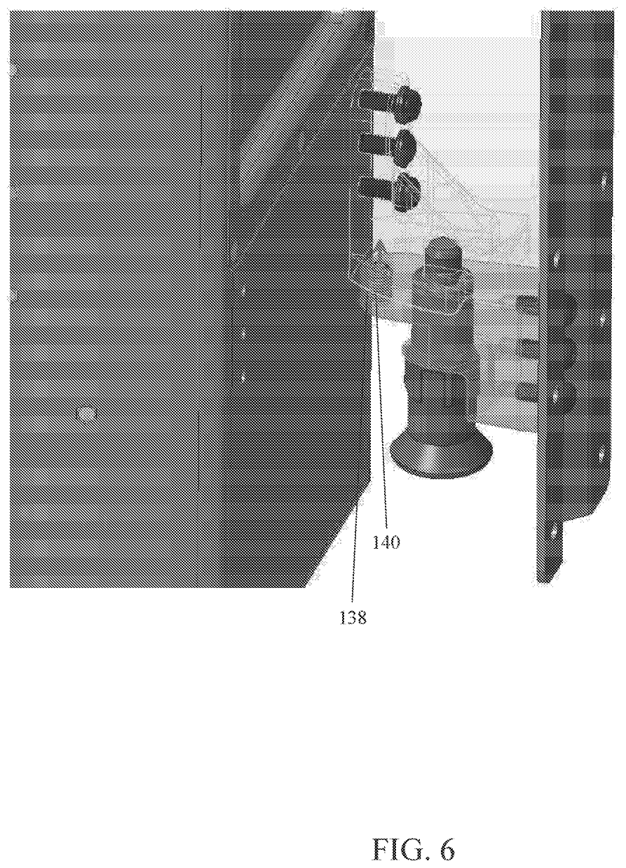

Once pan rotation of the speakers has been adjusted, the mounting apparatus 100 is configured to lock the axial rotation of the device mounting member 106 utilizing the locking means 138. For example, as shown in FIG. 6, in the embodiment wherein the locking means 138 is a knurled point set screw 140, the set screw may be received and screwed in the distal aperture 136 of the fixed mounting member until the distal end of the set screw extends through the aperture 136 and contacts the contacting surface 134 of the device mounting member. When the distal end of the set screw 140 contacts the contacting surface 134, the set screw applies pressure on the contacting surface to restrict further rotational movement of the device mounting member. The set screw 140 preferably has a knurled distal face for an improved frictional grip on the contacting surface 134. The lateral extension portions 132 on the device mounting member increase the surface area of the contacting surface 134 (effective to provide more engaging surface for the locking means 138) and permit a larger area or range of rotation in which the position of the speaker may be locked.

An installed speaker that has been mounted utilizing the mounting apparatus 100 may be removed by releasing the locking means 138. For example, when the locking means 138 is a set screw 140, the set screw may be unscrewed and loosened until the distal end of the set screw does not contact the contacting surface 134 of the device mounting member. The installer may then pull the knob 116 of the plunger securement device so that the plunger pin 114 is out of the recess and within the first aperture of the fixed mounting member; as such, the plunger pin is displaced from the recess 122. The speaker 101 may then be moved away from the wall in order to remove the device mounting member from the fixed mounting member 104.

In a preferred embodiment, the knob includes a retaining member, such as a raised tab, which is configured to be received in a notch 142 on the plunger securement device to retain the plunger in an extended position. For example, the knob may be rotated so that the retaining member is aligned with the notch. The knob is then released and the biasing force forces the retaining member within the notch to secure an extended position of the knob. This prevents the biasing means from forcing the plunger pin 114 into the recess 122 while the speaker is being removed.

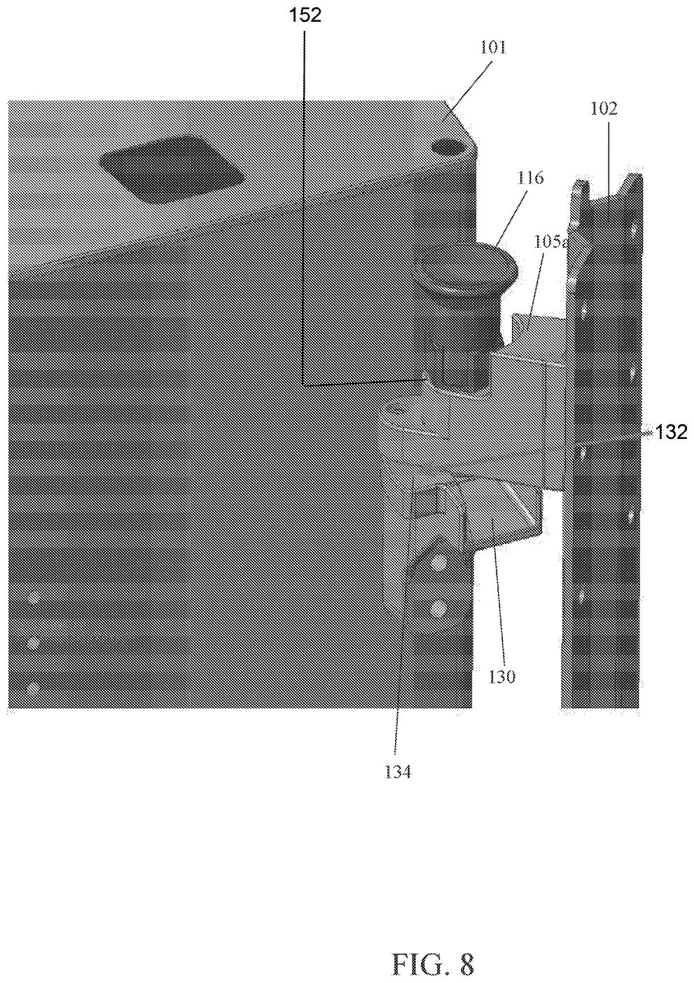

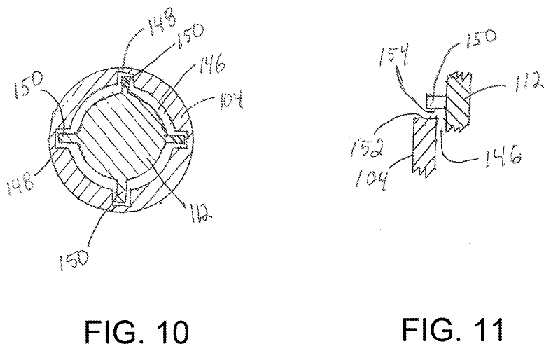

FIG. 10 schematically shows a vertical aperture 146 having a plurality of vertically-extending channels or slots 148 defined by the surrounding body of the fixed mounting member 104. The plunger securement device 112 has a plurality of projections 150 extending from the side of the plunger securement device 112; the projections 150 are preferably posts, knobs, or vertically-extending ribs. The projections 150 are vertically slidable in the channels 148. With reference to FIGS. 10-11, when the plunger securement device 112 is slid or pulled a predetermined distance in the aperture 146 against the biasing force (e.g., upwardly in FIG. 8), a bottom 154 of the projection 150 emerges from the channel 148 so that the plunger securement device 112 can be rotated clockwise or counterclockwise (with respect to the longitudinal axis defined by the aperture 146) so that the bottom 154 of the projection 150 is located above a shelf or ledge 152 defined by the fixed mounting member 104 adjacent the aperture 146 and the bottom 154 is forced by the biasing force into resting contact with the shelf or ledge 152 (the shelf 152 can have a notch or divot; the bottom 154 can rest in the notch and be restrained from moving left or right). The installer can do this to prevent the biasing means from forcing the plunger pin 114 into the recess 122 while the speaker is being removed.

The present invention is also directed to a method for mounting a speaker or other mountable device. The method includes the step of securing at least one fixed mounting member having the structural features as described above to a wall bracket or directly to a wall or other supporting structure. At least one device mounting member having the structural features as described above is secured to a cabinet of the speaker. The device mounting member is then releasably secured to the fixed mounting member by moving the distal end of the device mounting member into contact with the distal portion of the fixed mounting member and then moving the speaker towards the wall until the distal end of the plunger pin is received in the recess of the device mounting member, as described above. The axial or pan rotation of the device mounting member may then be adjusted. The axial rotation of the device mounting member may then be locked by locking means as described above.

The method may also include the steps of removing the speaker by releasing the locking means, releasing the securement of the device mounting member to the fixed mounting member by pulling the plunger pin to displace the distal end of the plunger pin from the recess and removing the device mounting member from the fixed mounting member.

Having described preferred embodiments for a mounting apparatus and methods (which are intended to be illustrative and not limiting), it is noted that modifications and variations can be made by persons skilled in the art in light of the above teachings. It is therefore to be understood that changes may be made in the particular embodiments of the disclosure disclosed which are within the scope of the embodiments disclosed herein as outlined by the appended claims. Having thus described the details and particularity required by the patent laws, what is claimed and desired protected by Letters Patent is set forth in the appended claims.

What is claimed is:

1. A mounting apparatus for a mountable device, the mounting apparatus comprising a first device mounting member and a first fixed mounting member, the first device mounting member having (a) a recess extending vertically and (b) an entrance-way which is provided with an angled surface, the entrance-way extending towards the recess, the first fixed mounting member having (a) a plunger securement device slidable in an aperture extending vertically in the first fixed mounting member and (b) a biasing element which provides a biasing force, the plunger securement device having a plunger pin at a first end and a knob at a second end, the biasing element being effective to bias the plunger pin in an extended position extending from the aperture, the first fixed mounting member having a horizontal contacting surface adjacent the plunger pin which is slidable with respect to a horizontal contacting surface of the first device mounting member adjacent the recess of the first device mounting member such that, when a distal portion of the first fixed mounting member horizontal contacting surface slides a first distance on or towards the first device mounting member horizontal contacting surface, a distal portion of the plunger pin contacts the angled surface, which forces the plunger pin to retract in a direction into the aperture and against the biasing force, and when the distal portion of the first fixed mounting member horizontal contacting surface slides a further distance on the first device mounting member horizontal contacting surface, the distal portion of the plunger pin arrives at the recess and extends into the recess via the biasing force.

2. The mounting apparatus of claim 1, further comprising a second device mounting member and a second fixed mounting member, wherein the second device mounting member and the second fixed mounting member have the same corresponding features as the first device mounting member and the first fixed mounting member, respectively.

3. The mounting apparatus of claim 2, wherein each of the first and second fixed mounting members has a locking means such that each respective device mounting member can be fixed in position with respect to its respective fixed mounting member with regard to rotation around a vertical axis.

4. The mounting apparatus of claim 3, wherein each locking means is a set screw.

5. The mounting apparatus of claim 2, wherein each device mounting member is rotatable around a vertical axis with respect to its respective fixed mounting member, when a plunger pin of said respective fixed mounting member is engaging a recess of said device mounting member.

6. The mounting apparatus of claim 2, wherein each of the angled surfaces extends generally in a direction towards a mouth of a respective recess.

7. The mounting apparatus of claim 3, wherein each device mounting member is rotatable at least 90° around a vertical axis with respect to its respective fixed mounting member, when a plunger pin of said respective fixed mounting member is engaging a recess of said device mounting member, and wherein each device mounting member can be fixed in position with respect to its respective fixed mounting member via the locking means at any point of the at least 90° of rotation.

8. The mounting apparatus of claim 3, wherein each device mounting member is rotatable at least 180° around a vertical axis with respect to its respective fixed mounting member, when a plunger pin of said respective fixed mounting member is engaging a recess of said device mounting member, and wherein each device mounting member can be fixed in position with respect to its respective fixed mounting member via the locking means at any point of the at least 180° of rotation.

9. The mounting apparatus of claim 3, wherein each device mounting member has one or more laterally extending portions on its sides effective to provide an engaging surface for the locking means of its respective fixed mounting member.

10. The mounting apparatus of claim 2, wherein each angled surface has an inclined or declined angle between 15 and 75 degrees.

11. The mounting apparatus of claim 2, wherein each device mounting member and each fixed mounting member has a proximal portion which has a plurality of apertures, cavities or fastening elements configured so that the respective mounting member can be secured to a respective mountable device or a support structure.

12. The mounting apparatus of claim 2, wherein the plunger securement device has a projection extending from a side of the plunger securement device, the aperture defining a vertically-extending channel, the projection being slidable in the channel such that, when the plunger securement device is slid a predetermined distance in the aperture against the biasing force, a bottom of the projection emerges from the channel so that the plunger securement device can be rotated clockwise or counterclockwise with respect to a longitudinal axis defined by the aperture so that the bottom of the projection can be forced by the biasing force into resting contact with a shelf defined by the fixed mounting member adjacent the aperture.

13. The mounting apparatus of claim 2, wherein the first and second device mounting members or the first and second fixed mounting members are mounted on an audio speaker.

14. The mounting apparatus of claim 13, further comprising a support structure, wherein the plunger pin of the first fixed mounting member extends into the recess of the first device mounting member so that the first fixed mounting member and the first device mounting member are engaged together, wherein the plunger pin of the second fixed mounting member extends into the recess of the second device mounting member so that the second fixed mounting member and the second device mounting member are engaged together, wherein the first and second fixed mounting members or the first and second device mounting members are mounted on the support structure, wherein the first fixed mounting member is mounted above the second fixed mounting member, wherein the knob of the first fixed mounting member extends upwardly and wherein the knob of the second fixed mounting member extends downwardly.

15. The mounting apparatus of claim 14, wherein the first and second fixed mounting members are locked via a respective locking means to the first and second device mounting members, respectively, each locking means locking the respective fixed and device mounting members together with respect to rotation around a vertical axis.

16. The mounting apparatus of claim 2, wherein the biasing element is a spring.
